(19) United States
(12) Patent Application Publication
(10) Pub. No.: US 2008/0272340 A1
(43) Pub. Date: Nov. 6, 2008

(54) Method for Producing Syngas with Low Carbon Dioxide Emission

(76) Inventor: Daphne Koh, Paris (FR)

Correspondence Address: AIR LIQUIDE;Intellectual Property, 2700 POST OAK BOULEVARD, SUITE 1800, HOUSTON, TX, 77056, US

(21) Appl. No.: 11/815,250

(22) PCT Filed: Jan. 24, 2006
(86) PCT No.: PCT/FR2006/050050

§ 371 Date: May 19, 2008

(30) Foreign Application Priority Data
Feb. 1, 2005 (FR) 0550297

(51) Int. Cl. C01B 3/02

(52) U.S. Cl. 252/373

(57) ABSTRACT

The invention concerns a method for producing syngas by means of a syngas producing unit comprising: at least one syngas producing reactor producing from hydrocarbons: a crude syngas comprising hydrogen, CO and CO₂ and an exhaust gas comprising CO₂; a device for eliminating CO₂ from said crude syngas producing a gas comprising essentially CO₂, said gas comprising essentially CO₂ being recycled into the syngas producing reactor on an industrial site further comprising: at least one heat and/or electricity producing unit producing an exhaust gas comprising CO₂; a device for eliminating CO₂ from the combustion exhaust gases of the site, wherein: at least one of the exhaust gases comprising CO₂ produced by the syngas producing reactor or by the heat and/or electricity producing unit is treated in the device eliminating CO₂ from the combustion exhaust gases of the site; and the CO₂ produced by treating the exhaust gases of the syngas producing unit and/or the heat and/or electricity producing unit by the device eliminating CO₂ from the combustion exhaust gases of the site is recycled at least partly into the syngas producing reactor.

The present invention relates to a method that makes it possible to reduce the carbon dioxide emissions from boilers, gas turbines and/or integrated steam and electricity production units on a syngas production site.

The invention touches on various branches of industry, such as the heavy chemical industry, the petrochemical industries, the refining industry and the energy industry, all affected by environmental protection.

All these industries may carry out the conversion of heavy hydrocarbons to chemicals of which more use can be made, by means of the production of a syngas. A syngas is a mixture of CO, H₂, CH₄, CO₂ and H₂O obtained by steam methane reforming (SMR), partial oxidation of hydrocarbons or by autothermal reforming (ATR). Steam methane reforming is a process used to produce a syngas rich in CO from hydrocarbons ranging from natural gas to heavy naphtha. The process of partial oxidization or POX is a noncatalytic reaction between the hydrocarbons, coke or coal with steam and oxygen at high temperature and pressure. It is also possible to obtain the syngas by combining the SMR reforming and partial oxidation in the same reactor according to the process of autothermal reforming. The hydrocarbons treated by ATR are generally natural gas and naphtha. This ATR process results in syngases having a low H₂/CO ratio. The syngas also comprises nitrogen when the base reactant is natural gas. Depending on the operating conditions and the use to which the syngas is intended, the composition of a syngas may vary in the following amounts:
H₂+CO=75% to 97% by volume;
CH₄=0.5% to 18%; and
CO₂=2% to 10%.

It is then treated in a unit for removing carbon dioxide. If CO is the product desired in the production of the syngas, the carbon dioxide recovered may be recycled into the reactant intended to be treated by the syngas production reactor. If not, the CO₂ obtained must be stored or recycled as the environmental standards henceforth prohibit its release. Carbon dioxide may also be found in the fumes or exhaust gases from the syngas production reactor. These fumes are generally released into the atmosphere which does not meet the environmental standards.

The invention relates to the syngas production sites in which technologies producing combined heat and power (CHP) such as conventional boilers are also used. In the energy industry, these CHP technologies may be plants for cogeneration of electricity which consist of an open cycle or a combined cycle. Cogeneration is the simultaneous production of electricity and steam where the electricity is produced by an alternator driven by a turbine (usually a gas or steam turbine) and where the heat comes from the heat of the exhaust gases stemming from a boiler for steam or hot water production. This combined generation of two types of energy results in yields of high efficiency in comparison with the separate and conventional production of heat and/or electricity. Thus, to meet the increasing demand for syngas derivatives, for steam and for electricity, production sites are increasingly sought which may simultaneously provide syngas derivatives, steam and electricity. However, one current problem of these production sites is being able to meet these environmental constraints by limiting the release of carbon dioxide. An additional problem is finding a storage solution for the carbon dioxide removed from the gases produced by the syngas unit while having an improved reliability, reduced costs and respect for the environment.

The object of the present invention is to provide a method for producing syngas, on a site that also comprises a combined heat and power unit, which emits little carbon dioxide.

Another object of the present invention is to provide a method for producing syngas, on a site that also comprises a combined heat and power unit, which emits little carbon dioxide and does not require storage of the carbon dioxide.

Another object is to provide a method for producing syngas, on a site that also comprises a combined heat and power unit, which emits little carbon dioxide and allows control of the H₂/CO ratio of the syngas produced.

Within these objectives, the invention relates to a method for producing a syngas using a syngas production unit comprising:
at least one syngas production reactor producing from hydrocarbons:
   a crude syngas comprising hydrogen, CO and CO₂; and
   an exhaust gas comprising CO₂,
a device for removing CO₂ from said crude syngas producing a gas that mainly comprises CO₂, said gas that mainly comprises CO₂ being recycled into the syngas production reactor,
   on an industrial site additionally comprising:
at least one combined heat and power unit producing an exhaust gas comprising CO₂; and
a device for removing CO₂ from the combustion exhaust gases of the site,
   in which method:
at least one of the exhaust gases comprising CO₂ produced by the syngas production reactor or by the combined heat and power unit is treated in the device for removing CO₂ from the combustion exhaust gases of the site; and
the CO₂ produced by treating the exhaust gases from the syngas production unit and/or from the combined heat and power unit via the device for removing CO₂ from the combustion exhaust gases of the site is at least partly recycled into the syngas production reactor.

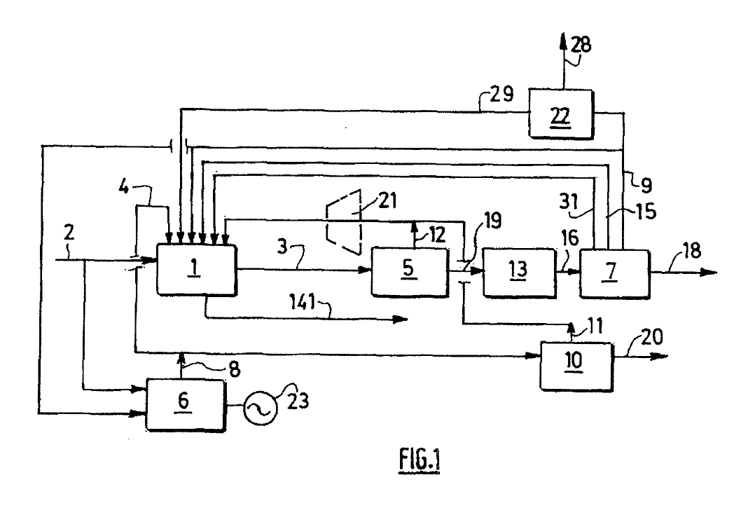

Other features and advantages of the invention will appear on reading the description that follows. Forms and embodiments of the invention are given by way of nonlimiting examples, illustrated by FIGS. 1 to 4 which are schematic representations of several variants of the method according to the invention.

The method according to the invention therefore uses a syngas production unit that comprises at least, on the one hand, the syngas production reactor that makes it possible to obtain the crude syngas and, on the other hand, a device for treating this crude syngas in order to eliminate the carbon dioxide therefrom.

The syngas production reactor that makes it possible to obtain the crude syngas may be a steam methane reforming (SMR) reactor or a partial oxidation (POX) reactor using hydrocarbons to produce the crude syngas that comprises hydrogen, carbon monoxide, carbon dioxide and other compounds. It may also be a reactor for implementing an ATR process. Due to a combustion being carried out in the syngas production reactor (combustion intended to raise the temperature of the reactor for the implementation of the synthesis reaction), the syngas production reactor also produces an exhaust gas in addition to the syngas. This exhaust gas comprises CO₂ as it generally results from the combustion of hydrocarbons.

The device for treating the crude syngas in order to eliminate the carbon dioxide therefrom is preferably a method of washing with amines that generally uses MDEA (methyldiethanolamine). The CO₂ is removed from the crude syngas in the form of a gas that mainly comprises CO₂ (that is to say, that comprises at least 99% by volume of CO₂) which is recycled as a reactant in the syngas production reactor.

According to a first mode of the invention, the syngas production unit comprises a device for removing CO from the syngas producing a gas that mainly comprises CO and a gas that mainly comprises H₂. This mode is implemented when the industrial site aims to mainly produce carbon monoxide. This device for removing CO from the syngas is usually positioned after the device for removing CO₂ from said crude syngas. The device for removing CO from the syngas usually comprises a drying device and a cold box. Thus, the syngas derived from the device for removing CO₂ is first dried before being introduced into a cold box, in which its various compounds are separated by cryogenic means. The cold box produces at least one gas that mainly comprises CO (that is to say that preferably comprises at least 98% by volume of CO), a gas that mainly comprises H₂ (that is to say that preferably comprises at least 97% by volume of H₂), a gas that mainly comprises CH₄ (that is to say that preferably comprises at least 99% by volume of CH₄) and an off-gas that comprises a mixture of H₂, CO and CH₄. Recycling the CO₂ upstream of the cold box makes it possible to reduce the amount of nitrogen in the gas that mainly comprises CO. The off-gas, the gas that mainly comprises CH₄ and the gas that mainly comprises H₂ may be used as fuels in all the combustion reactions carried out on the industrial site and especially in the combustion reaction carried out in the syngas production reactor or in the combustion reaction carried out in the combined heat and power unit. The gas that mainly comprises CH₄ may also be introduced into the syngas production reactor in order to be used as a reactant. According to a particular configuration of this first mode, it is possible to adjust the H₂/CO molar ratio of the syngas stemming from the drying device before introducing it into the cold box; this adjustment may be carried out by means of a membrane separation process. According to this first mode, the syngas production unit preferably comprises a device for purifying the gas that mainly comprises H₂ produced by the device for removing CO from the syngas, said purification device producing a gas enriched with H₂. This device for purifying the gas that mainly comprises H₂ preferably uses a pressure swing adsorption PSA process. This method of purifying the gas that mainly comprises H₂ produces an off-gas that mainly comprises a mixture of hydrogen, CO and CH₄. This off-gas may be used as a fuel in all the combustion reactions carried out on the industrial site and especially in the syngas production reactor and the combustion reaction carried out in the combined heat and power unit.

According to a second mode of the invention, the syngas production unit comprises a device for adjusting the value of the H₂/CO molar ratio of the syngas. This mode is implemented when the industrial site aims to mainly produce an oxogas. The device for adjusting the value of the H₂/CO molar ratio of the oxogas generally comprises a hydrogen-permeable membrane. The choice of the selectivity of the membrane makes it possible to adjust the H₂/CO ratio of the oxogas. The membrane also produces a hydrogen permeate which may be used as a fuel in all the combustion reactions carried out on the industrial site and especially in the syngas production reactor and the combustion reaction carried out in the combined heat and power unit. The permeable membrane may sometimes be preceded by a drying device.

According to the invention, the industrial site on which the syngas production unit is located comprises, in addition, at least one combined heat and power (CHP) unit, this unit producing an exhaust gas that comprises CO₂. According to the invention, a combined heat and power unit producing an exhaust gas comprising CO₂ may comprise at least one of the following devices: a gas turbine, a boiler for steam production, a steam turbine, or a combination of these devices, especially the combination of the steam boiler with the steam turbine and the combination of the gas turbine with the steam boiler, which may be combined with the steam turbine. The gas turbine is a commonly known device comprising an air compressor connected to a gas turbine. The compressed air produced is introduced with a fuel into the combustion device of the turbine and the combustion gases produced pass through the gas turbine to produce electricity, for example by means of an alternator. The fuel for the gas turbine is generally natural gas; according to the first mode of the invention, the natural gas may be mixed with at least one gas chosen from: the gas that mainly comprises H₂ produced by the device for removing CO from the syngas, the gas that mainly comprises CH₄ produced by the device for removing CO from the syngas, the gas enriched with H₂ produced by the purification device and the off-gas from the cold box. The boiler for steam production consists, itself, generally of a combustion device producing heat to transform water into steam. This boiler generally consists of a series of heat exchangers, for example coils, in which water flows, which are in contact with the heat produced by the combustion. This boiler may be combined with a steam turbine: thus, the steam pressure produced by the boiler passes into a steam turbine so as to produce electricity. The steam turbine may be either a backpressure steam turbine which produces steam and electricity, or a condensing stream turbine which produces hot water and electricity. According to one particular variant, the steam turbine may be partly supplied with steam produced by the heat derived from the syngas production reactor. The combined heat and power (CHP) unit produces exhaust gases that comprise CO₂ due to the combustions that are carried out therein in order to provide heat, especially by combustion of natural gas.

Finally, according to the invention, the industrial site comprises a device for removing CO₂ from the combustion exhaust gases capable of being produced on the site. This device makes it possible to treat all the exhaust gases derived from a combustion and comprising CO₂. The exhaust gases derived from a combustion generally comprise 13 to 16% by volume of oxygen. The device for removing CO₂ from these gases must therefore be suitable for treating gas that has such an oxygen content. It is impossible, for example, to use the device for removing CO₂ from the crude syngas because a crude syngas only contains a few ppb of oxygen. This device for removing CO₂ may be an amine wash using MEA (methylethanolamine) or a process of adsorbing carbon dioxide by means of screens or a membrane permeation process.

A first main feature of the invention relates to the fact that at least one of the exhaust gases comprising the CO₂ produced, either via the syngas production reactor, or via the combined heat and power (CHP) unit, is treated in the device for removing CO₂ from the combustion exhaust gases of the site. According to the invention, there may be treatment either of the exhaust gases derived from the syngas production unit, or the exhaust gases derived from the combined heat and power unit, or the exhaust gases stemming from both of these units. The choice is usually made depending, at the same time, on the CO₂ content of each exhaust gas and on the rate of recycling desired in the syngas production reactor. If the exhaust gases stemming from both the syngas production unit and the combined heat and power (CHP) unit are treated by the device for removing CO₂ from the exhaust gases of the site, then the exhaust gas from the syngas production reactor is preferably mixed with the exhaust gas from the combined heat and power (CHP) unit prior to being introduced into the device for removing CO₂ from the combustion exhaust gases of the site.

A second main feature of the invention is that the CO₂ produced by the device for removing CO₂ from the exhaust gases of the syngas production unit and/or from the combined heat and power (CHP) unit is at least partly recycled into the syngas production reactor. The CO₂ from the exhaust gases is recycled as a reactant in the syngas production reactor. As the CO₂ produced by the device for removing CO₂ from the exhaust gases may comprise poisons for the catalysts of the syngas reactor, this CO₂ may be treated by at least one of the following devices, and preferably by both:
two combined beds of activated carbon, the first bed being impregnated with sulfur so as to adsorb Hg and the second being impregnated with copper and silver to adsorb H₂S and HCN and to oxidize AsH₃; and
a deoxo reactor charged with aluminum to adsorb the ion compounds and comprising, downstream, a charge of catalyst based on copper and palladium to remove O₂, C₂H₄ and NOx.

During this treatment for removing poisons, the CO₂ may be compressed and undergo temperature changes, for example by means of a heat exchanger, before being reintroduced into the syngas reactor. Generally, the CO₂ coming from the device for removing CO₂ from the crude syngas and the treated CO₂ coming from the device for removing CO₂ from the exhaust gases are mixed before being recycled into the syngas production reactor. The amount of CO₂ produced by the devices for removing CO₂ that is recycled into the syngas production reactor is mainly adjusted as a function of the desired H₂/CO ratio of the syngas. In certain cases, the industrial site may require the use of CO₂ as an intermediary in a synthesis step; in this case, some of the CO₂ is not recycled. According to one variant, at least some of the CO₂ produced by the devices for removing CO₂ from the syngas production and combined heat and power (CHP) units may be compressed before being recycled as a reactant into the syngas reactor, for example by means of an existing compressor which is usually intended for the syngas production unit.

According to one particular case, the steam turbine of the CHP unit may be coupled to a compressor. This compressor may optionally compress the mixture of exhaust gases produced by the boiler and the syngas production reactor prior to introducing them into the device for removing CO₂ from the combustion exhaust gases of the site, especially if the removal device is an adsorption process or a membrane permeation process. This compression enables a subsequent improved treatment of the gases.

Finally, according to the method of the invention, the H₂/CO ratio of the crude syngas may be controlled by the recycling rate of the CO₂ produced by the devices for removing CO₂ from the syngas production unit and from the combined heat and power unit in the syngas production reactor. Thus, according to the invention, it is possible to alter the amount of recycling of the CO₂ derived from the treatment of the exhaust gases. If the amount recycled is less than 100%, the unrecycled CO₂ may be exported outside the plant for applications requiring the use of CO₂, the industrial site then becoming a site that produces useable CO₂. According to one advantageous mode, the syngas production unit may not comprise a device for adjusting the value of the H₂/CO molar ratio of the syngas, such as a membrane. Indeed, since the method according to the invention makes it possible to control the H₂/CO ratio at the outlet of the syngas production reactor, it is therefore possible to remove the device for adjusting the value of the H₂/CO molar ratio (for example, a membrane) when the product manufactured by the syngas production unit is an oxogas.

FIG. 1 illustrates the method according to the invention. Hydrocarbons 2 undergo a catalytic reforming or partial oxidation or autothermal reforming (ATR) reaction in the reactor 1 so as to produce the crude syngas 3. The reactor 1 also produces an exhaust gas 4 comprising the gases derived from the combustion of the hydrocarbons used as fuels (and not as reactants). The crude syngas 3 is treated in the unit 5 for removing CO₂, which produces a CO₂-depleted syngas 19 and a CO₂-rich effluent 12. The CO₂-depleted syngas 19 is then dried in the dryer 13 to increase the removal of CO₂ and water and to prevent their presence in the cold box 7. The dried gas 16 is treated in a cold box 7. In the cold box, the temperature of the dried syngas 16 is reduced so as to separate the CO from the other compounds (H₂, N₂ and CH₄). It produces a gas that mainly comprises CO 18, a gas that mainly comprises H₂ 9 and an off-gas 15. The off-gas 15, which exits the stripping column (commonly denoted as the “flash gas”), is a mixture of H₂, CO and CH₄ which may be used as a fuel for the syngas production reactor 1 or in a combustion reaction carried out in the combined heat and power unit. The methane purge 31 which exits from the bottom of the CO/CH₄ separation column of the cold box 7 may also be used as a fuel or as reactants for the syngas production reactor 1, depending on its pressure value and the conditions required for the catalytic reaction.

The gas that mainly comprises H₂ 9 exiting from the cold box 7 may be treated in a hydrogen purification process 22 to produce high-purity hydrogen 28 and an off-gas 29 (also called “tail gas”). The off-gas 29 is used as a fuel in the syngas production reactor 1 and in the combustion reaction carried out in the combined heat and power unit.

The industrial site also comprises a combined heat and power unit 6, of which the heat is obtained by combustion of hydrocarbons 2 and of the gas that mainly comprises H₂ 9 from the cold box. This unit 6 produces electricity 23 and an exhaust gas 8 comprising carbon dioxide. This exhaust gas 8 is mixed with the exhaust gas 4 from the syngas production reactor. This exhaust gas mixture (8+4) is treated by the device 10 for removing CO₂ from the combustion exhaust gas of the site. This device 10 is preferably chosen from the devices for removing CO₂ that make it possible to treat a low-pressure effluent having a low oxygen content. Exiting from this device 10 is a CO₂-lean exhaust gas 20 and a CO₂-rich effluent 11, which is mixed with the CO₂-rich effluent 12 derived from the device 5 for removing CO₂ from the syngas production unit. This CO₂-rich mixture (11+12) may be compressed by a compressor 21 before being introduced into the reactor 1 with the hydrocarbons 2. The CO₂-lean exhaust gas 20 may be emitted into the atmosphere with a very low CO₂ content relative to the other products contained in the exhaust gases.

Air or oxygen (not shown) is supplied for all the devices 1, 6 carrying out a combustion.

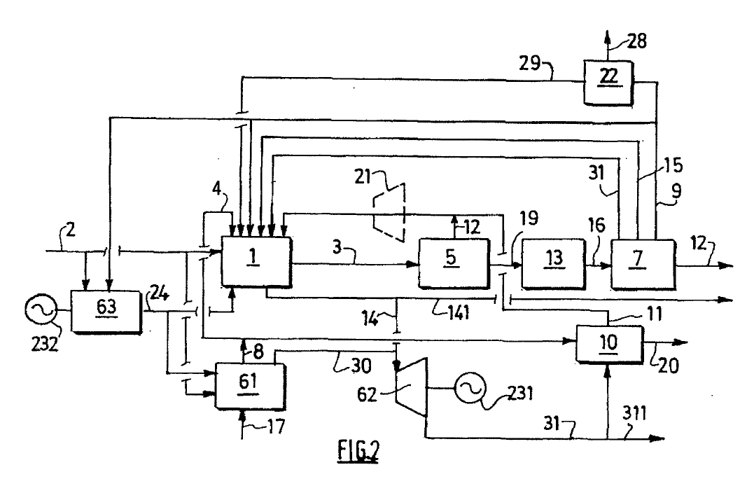

FIG. 2 differs from FIG. 1 by the fact that the combined heat and power unit 6 is a combination of a gas turbine 63, a boiler 61 and a steam turbine 62. The gas turbine 63 operates by combustion of hydrocarbons 2 and gas that mainly comprises H₂ 9 from the cold box. The boiler 61 receives the exhaust gas 24 from the gas turbine 63; it is supplied with water 17 and produces steam 30 which is used to turn the steam turbine 62 in order to produce electricity 231. The steam turbine 62 may also be supplied with the steam 14 produced by the water coming into contact with the reactor 1. The steam 31 exiting the steam turbine 62 may be used to carry out the treatment of removing CO₂ in the device 10. The gas turbine 63 operates by means of hydrocarbons 2 and gas that mainly comprises H₂ 9 coming from the cold box 7. It produces electricity 232 and a combustion gas 24 which is partly used for the combustion carried out in the boiler 61 and partly for the combustion carried out in the syngas production reactor 1. The electricity produced by the turbines 62 and 63 may be exported or used inside the site to operate electrical equipment.

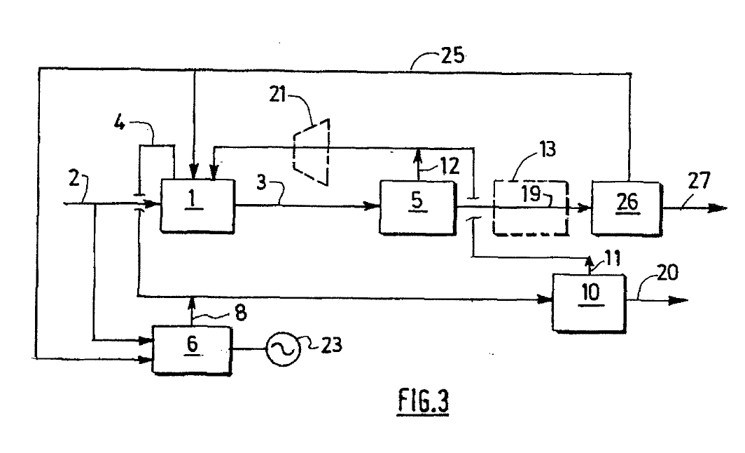

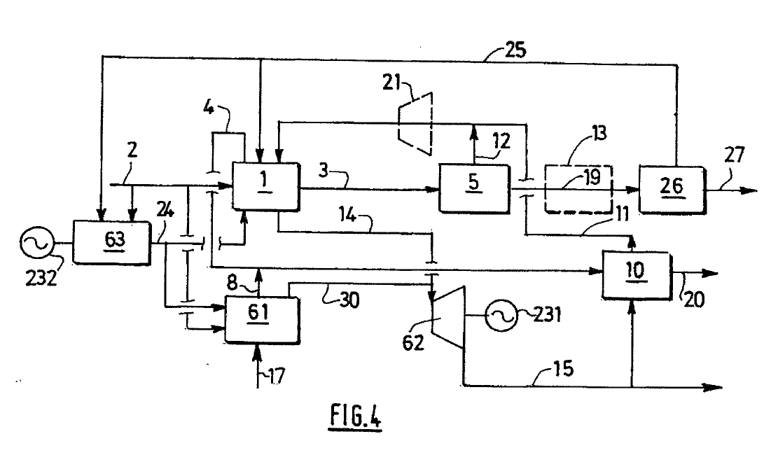

FIGS. 3 and 4 differ respectively from FIGS. 1 and 2 by the fact that the syngas unit aims to produce an oxogas. Consequently, the cold box is replaced by a device 26 for adjusting the H₂/CO molar ratio of the syngas producing an oxogas 27 and a gas that mainly comprises hydrogen 25 (and a smaller portion of CO) which may be used in the syngas production reactor 1 and in the combined heat and power unit 6. The syngas may optionally be dried by a drying device 13 before being introduced into the membrane. According to one particular mode, the dried syngas 16 may straight away have the desired H₂/CO molar ratio of the oxogas. For this mode, the membrane 26 may then be replaced with a simple condenser, the condensed water recovered possibly being reused in the syngas production reactor (1) or in the combined heat and power unit (6, 61).

By implementing the method as described previously, the emissions of carbon dioxide are considerably reduced and it is no longer necessary to find a means of storing the CO₂ produced.

One advantage of the method is that it makes it possible to decrease the consumption of hydrocarbons, for example natural gas, naphtha or liquefied petroleum gas (LPG) due to the recycling of CO₂ in the syngas production reactor.

When the main product of the syngas production unit is CO, another advantage of the invention is that it is possible to obtain a carbon recovery rate of around almost 100% if all the CO₂ derived from the exhaust gases is recycled.

Due to the integration of the various units, the following advantages are obtained:
improved energy efficiency;
recovery of almost 100% of the carbon, hence decrease of the CO₂ emissions;
improved reliability;
synergy of operations and maintenance;
economic benefit; and
decrease of NOx and SOx emissions in the exhaust gases.

The method according to the invention has the advantage of enabling the decrease of the H₂/CO ratio downstream of the device for removing CO₂ from the syngas production unit. This decrease is obtained by recycling CO₂ from various devices that produce gases containing CO₂. Via their recycling in the syngas production reactor, the gas produced has a lower H₂ concentration.

### EXAMPLES

Several simulations have been carried out based on a syngas production unit implementing an SMR reaction by means of a natural gas having the following composition:

| | |
|---|---|
| CH₄: | 96.696 vol % |
| N₂: | 0.397 vol % |
| C₂H₆: | 2.327 vol % |
| C₃H₈: | 0.192 vol % |
| C₄H₁₀ (n-butane): | 0.377 vol % |
| C₅H₁₂ (n-pentane): | 0.010 vol % |
| CO₂: | 0.001 vol % |

The simulation was carried out for three different cases:
the base case corresponded to a site that included one syngas production unit and one combined heat and power unit, in which there was no recycling of the CO₂ (8) produced by the combined heat and power unit or stemming from the exhaust gases (4) from the syngas production reactor to the syngas production unit. On the other hand, the CO₂ (12) stemming from the process for removing CO₂ from the crude syngas was recycled;
case 1 corresponded to the same site as in the base case, but with recycling of CO₂ derived from the exhaust gases of the syngas production reactor to the syngas production unit, but in which the CO₂ stemming from the exhaust gases of the combined heat and power unit was not introduced into the syngas production reactor. In this case, the CO₂ stemming from the exhaust gases of the CHP unit was emitted into the atmosphere; and
case 2 corresponded to the same site as in the base case, but with recycling of CO₂ derived from the exhaust gases of the syngas production reactor and CO₂ derived from the exhaust gases of the combined heat and power unit to the syngas production unit.

For these various cases, the preheated natural gas was introduced into the syngas production reactor which was a steam methane reforming (SMR) reactor, after having undergone a hydrodesulfurization treatment to remove sulfide traces therefrom. In all the cases, the recycled CO₂ stemming from the device for removing CO₂ from the syngas production unit was also introduced into the SMR reactor. This recycled CO₂ was first compressed.

All these reactants were heated at 650° C. and introduced into the tubes filled with nickel-based catalysts of the SMR reactor at 25 bar.

The device for removing CO₂ from the crude syngas was an amine wash. It made it possible to produce a syngas having a CO₂ content of less than 50 ppm by volume.

In case 2, the gas turbine 63 was a Solar Mars 100 model.

In cases 1 and 2, the unit for removing CO₂ from the exhaust gases of the combined heat and power unit was an amine wash, the purity of the dry CO₂ obtained was 99.9% by volume at room temperature and under about 0.55 bar relative.

Table 1 enables the methods for each case, and their economic impact, to be compared.

TABLE 1

| | | Base | | |
|---|---|---|---|---|
| | | case | Case 1 | Case 2 |
| CO produced (18) | Sm³/h | 9500 | 9500 | 9500 |
| H₂ produced (28) | Sm³/h | 24530 | 13835 | 8260 |
| Steam (141) exported | t/h | 24 | 20.6 | 18.8 |
| by the syngas | | | | |
| production unit | | | | |
| Steam (311) exported | t/h | 17.2 | 8.7⁽*⁾ | 4.2⁽*⁾ |
| by the combined heat | | | | |
| and power unit | | | | |
| All the steam | t/h | 41.2 | 28.0 | 21.7 |
| exported | | | | |
| Electricity (232 + 231) | MWe | 9 | 8.69⁽**⁾ | 8.45⁽**⁾ |
| produced by the | | | | |
| combined heat and | | | | |
| power unit | | | | |
| Natural gas used as | Sm³/h | 12080 | 7728 | 5550 |
| a reactant in the | | | | |
| syngas production | | | | |
| reactor (1) | | | | |
| Natural gas used as | Sm³/h | 1900 | 2209 | 2350 |
| a fuel in the syngas | | | | |
| production reactor | | | | |
| (1) | | | | |
| All the natural gas | Sm³/h | 13980 | 9937 | 7900 |
| used by the syngas | | | | |
| production unit | | | | |
| CO₂ (12) removed | Sm³/h | 3316 | 4741 | 7006 |
| from the crude syngas | | | | |
| and recycled | | | | |
| Natural gas (2) used | Sm³/h | 2717 | 2717 | 2717 |
| as a fuel in the | | | | |
| combined heat and | | | | |
| power unit | | | | |
| Natural gas used by | Sm³/h | 16697 | 12654 | 10617 |
| both units | | | | |
| Amount of CO₂ | Sm³/h | — | 3118 | 4775 |
| removed by means | | | | |
| of the device (10) for | | | | |
| removing CO₂ from | | | | |
| the exhaust gases | | | | |
| produced and | | | | |
| recycled as fluid | | | | |
| (11) | | | | |
| Rate of recovering | % | — | 85 | 80 |
| CO₂ in the device | | | | |
| (10) for removing CO₂ | | | | |
| from the combustion | | | | |
| exhaust gases of the | | | | |
| site | | | | |
| All the CO₂ | Sm³/h | 3316 | 7859 | 11781 |
| introduced into the | | | | |
| syngas production | | | | |
| reactor (1) | | | | |
| H₂/CO ratio at the | | 3.1 | 1.8 | 1.1 |
| outlet of the syngas | | | | |
| production reactor | | | | |
| (1) | | | | |
| Natural gas saved | Sm³/h | — | 4043 | 6080 |
| over both units | | | | |
| Saving in natural | MM$/yr | — | 6.71 | 10.10 |
| gas produced for an | (8400 h/y) | | | |
| operating cost of | | | | |
| 17$/MWh_{HHP} | | | | |
| (HHP: higher heating | | | | |
| power) | | | | |
| Capital expenditure | MM$/y | — | 1.18 | 1.55 |
| (investment over 15 | | | | |
| years and return on | | | | |
| investment of 13%) | | | | |
| Decrease of exported | MM$/y | — | −0.92 | −1.36 |
| steam (10$/MWh) | (8400 h/y) | | | |
| Decrease of exported | MM$/y | — | −0.10 | −0.17 |
| electricity | (8400 h/y) | | | |
| (35$/MWh) | | | | |
| Saving in CO₂ credit | MM$/y | — | 4.05 | 4.73 |
| assessed at 10$/t CO₂ | (8400 h/y) | | | |
| Total savings | MM$/y | — | 9.74 | 13.3 |
| | (8400 h/y) | | | |

(⁽*⁾= including steam used in the device (10) for removing CO₂);
(⁽**⁾= including power used in the device (10) for removing CO₂).

This example shows the economic advantage of recycling the CO₂ produced by all the units in the SMR reactor so as to decrease the consumption of all the natural gas (used as a reactant and as a fuel). In case 1, the consumption of all the natural gas consumed by the syngas production unit is already reduced to 71% of the base case. In case 2, the H₂/CO ratio is reduced to 1.1 and the consumption of all the natural gas consumed by the syngas production unit is reduced to 57% relative to the base case.

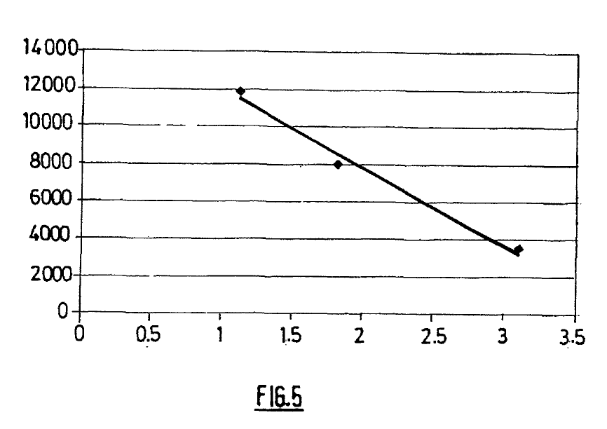

The graph from FIG. 5 gives the H₂/CO molar ratio (x-axis) at the outlet of the syngas production reactor as a function of the amount of CO₂ (in Sm³/h) (y-axis) recycled in the syngas production reactor. It can be seen that the relationship is linear; thus, depending on the required production of H₂ or CO, the method according to the invention makes it possible to vary, in a flexible manner, the H₂/CO ratio by adjusting the recycling rate of the CO₂, or even the importation of CO₂. This makes it possible, in addition, to avoid the addition of a membrane upstream of the cold box or PSA.

1.-17. (canceled)

18: A method for producing a syngas using a syngas production unit on an industrial site comprising:
wherein said syngas production unit comprises:
a) at least one syngas production reactor producing from hydrocarbons:
1) a crude syngas comprising hydrogen, CO and CO₂; and
2) a first exhaust gas comprising CO₂;
b) a first CO₂ removal device for removing CO₂ from said crude syngas thereby producing a gas that mainly comprises CO₂, said gas that mainly comprises CO₂ being recycled into said syngas production reactor,
wherein said industrial site comprises:
c) at least one combined heat and power unit producing a second exhaust gas comprising CO₂; and
d) a second CO₂ removal device for removing CO₂ from at least one of said first exhaust gas and said second exhaust gas, and
wherein:
e) at least one of said first exhaust gas and said second exhaust gas is treated in said second CO₂ removal device; and
f) the CO₂ produced by said first CO₂ removal device and/or from said second CO₂ removal device.

19: The method of claim 18, wherein said combined heat and power unit comprises at least one device selected from the list comprising: a gas turbine, a boiler for steam production, a steam turbine, and a combination of these devices.

20: The method of claim 18, wherein said syngas production unit comprises a device for removing CO from said syngas thereby producing a gas that mainly comprises CO and a gas that mainly comprises H₂.

21: The method of claim 20, wherein said device for removing CO from the syngas comprises a drying device and a cold box.

22: The method of claim 20, wherein said syngas production unit comprises a device for purifying the gas that mainly comprises H₂ produced by the device for removing CO from the syngas, said purification device producing a gas enriched with H₂.

23: The method of claim 22, wherein said device for purifying the gas that mainly comprises H₂ uses a pressure swing adsorption PSA process.

24: The method of claim 23, wherein said device for purifying the gas that mainly comprises H₂ uses a pressure swing adsorption PSA process and produces an off-gas that mainly comprises a mixture of H₂, CO and CH₄.

25: The method of claim 20, wherein said combined heat and power unit comprises a gas turbine, the fuel of said gas turbine being natural gas or a mixture of natural gas and at least one gas chosen from the group consisting of: said gas that mainly comprises H₂ produced by said device for removing CO from said syngas, said gas enriched with H₂ produced by said device for purifying said gas that mainly comprises H₂, said off-gas from said cold box and said methane purge from said cold box.

26: The method of claim 18, wherein said syngas production unit comprises a device for adjusting the value of the H₂/CO molar ratio of said syngas.

27: The method of claim 26, wherein said device for adjusting the value of the H₂/CO molar ratio is a hydrogen-permeable membrane.

28: The method of claim 27, wherein said hydrogen-permeable membrane is preceded by a drying device.

29: The method of claim 28, wherein said first exhaust gas is mixed with said second exhaust gas prior to being introduced into said second CO₂ removal device,

30: The method of claim 18, wherein the CO₂ produced said first CO₂ removal device and said second CO₂ removal device is compressed before being recycled to said syngas reactor.

31: The method of claim 18, wherein said combined heat and power unit comprises a steam turbine which is partly supplied with steam produced by the heat derived from said syngas production reactor.

32: The method of claim 18, wherein said combined heat and power unit comprises a steam turbine and in that at least some of the steam from said steam turbine is used in said second CO₂ removal device.

33: The method of claim 18, wherein the H₂/CO ratio of said crude syngas is controlled by the recycling rate of the CO₂ produced by said first CO₂ removal device and said second CO₂ removal device in said syngas production reactor.

34: The method of claim 33, wherein said syngas production unit does not comprise a device for adjusting the value of the H₂/CO molar ratio of said syngas.
